(19) United States
(12) Patent Application Publication
(10) Pub. No.: US 2008/0034518 A1
(43) Pub. Date: Feb. 14, 2008

(54) Counter clock-wise air buffer and sander

(76) Inventor: Eric D. Lindroth, Hartwick, NY (US)

Correspondence Address: SUNG I. OH, PROFESSIONAL LAW CORPORATION, 710 QUAIL VALLEY LANE, WEST COVINA, CA, 91791, US

(21) Appl. No.: 11/500,740

(22) Filed: Aug. 8, 2006

(51) Int. Cl. B60S 3/06

(52) U.S. Cl. 15/97.1; 15/28; 15/97.3

(57) ABSTRACT

A buffer rotates counterclockwise and is used in automobile finishing jobs. The buffer is pneumatic and is especially useful for professional finish technicians.

### TECHNICAL FIELD OF THE INVENTION

The present invention relates to the general art of power tools, and to the particular field of power tools used in automobile repair.

### BACKGROUND OF THE INVENTION

In the time of $10,000.00 automobile paint jobs and $4,000.00 per gallon paint, an automobile finish technician must be extremely careful during the application of a finish to an automobile. Any mistake can be extremely damaging and time consuming to repair. For this reason, finish technicians must be highly skilled and must have the most effective equipment.

One extremely delicate task that must be carried out with the utmost care is that of buffing the finish. Since an automobile has many curves and contours, buffing is not at all an easy task. A problem that may be encountered during buffing is often referred to as “SCORAGE,” which stands for “Scorch, gouge, scar, friction, burn.” This is caused by a buffing pad penetrating through layers of paint and requires time and money to repair. This problem is often caused by trying to use a buffer on a finish in a very difficult to reach location on the vehicle.

The inventor has discovered that if a correct tool is used in such difficult situations, the scarring problem may be reduced. However, this is not as easy as it sounds because at the present time, the only buffers that are available rotate in the clockwise direction. This creates problems for a technician trying to reach a difficult location, and may be especially trying for a left-handed technician.

Still further, in some buffing situations, debris should be controlled. However, with a clockwise rotating buffer, this may not be possible in all situations. Therefore, there is a need for a buffer that can be used in difficult situations, and especially a buffer that can be used by left-handed technicians. It is also noted that the tool disclosed herein can also be used as a cutting tool a sanding tool or a grinding tool when fitted with appropriate abrasive media.

### SUMMARY OF THE INVENTION

The above-discussed disadvantages of the prior art are overcome by a buffer that rotates counterclockwise and is also less weight than electrical machine. The buffer is pneumatic and thus is especially useful for professional finish technicians. The counterclockwise rotating buffer will provide another tool for a technician thereby providing the professional with further versatility.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a counterclockwise rotating automobile finish buffer embodying the present invention.

FIG. 2 is a side elevational view of the buffer shown in FIG. 1.

FIG. 3 shows a view of the buffer with the counterclockwise rotation being shown as well as a front fender of an automobile.

### DETAILED DESCRIPTION OF THE INVENTION

Referring to the figures, it can be understood that the present invention is embodied in an automobile finish buffer 10. Buffer 10 comprises a housing 12 and a support handle 14 mounted on the housing. A conduit 16 is contained in the support handle and is connected to a pneumatic source 18. An adjustable handle 20 is movably mounted on the housing to move clockwise and counterclockwise with respect to the housing and a rest element 22 is also mounted on the housing.

A pneumatic motor 30 is located in the housing. The motor operates in a counterclockwise direction with respect to the housing and with respect to the support handle. A buffer element 32 is mounted on the motor for rotation. As shown in FIG. 3, the buffer rotates counterclockwise with respect to a workpiece 34 when the buffer is interposed between the workpiece and the support handle. In the disclosed form, the workpiece 34 is an automobile body being finished.

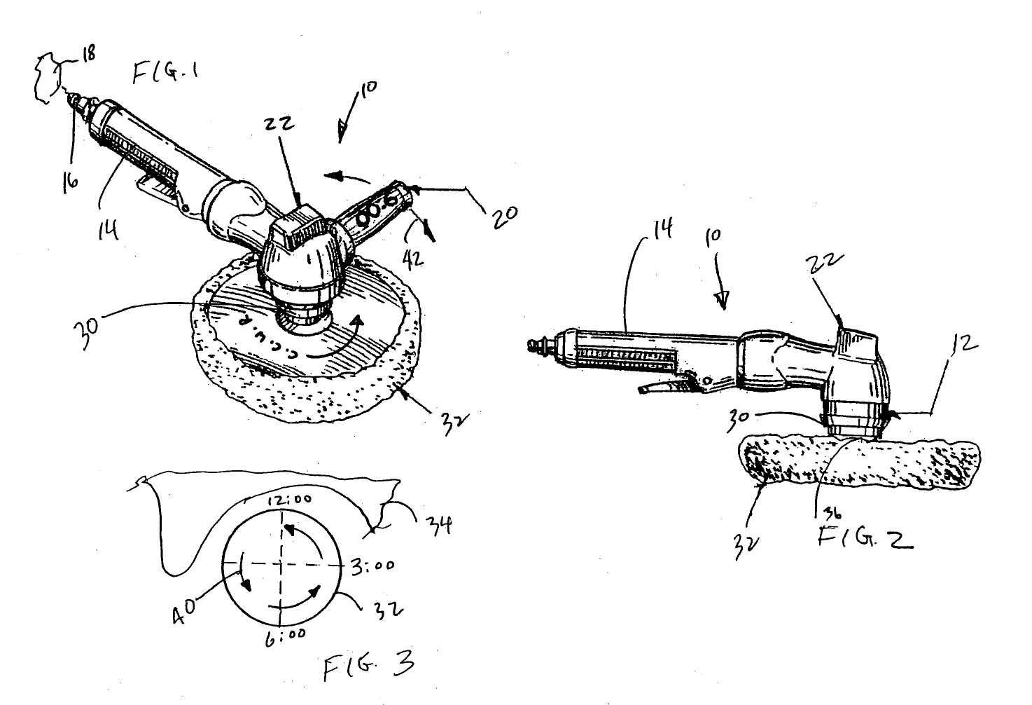

A suitable fastener 36 connects the buffer element to the motor so the buffer element, such as polishing fabric or sanding paper, can be rotated counterclockwise without being released from the motor. In accordance with the teaching of the present disclosure, especially with reference to FIG. 3, the present invention is also embodied in a method of buffing an automobile finish which comprises placing buffer element 32 in contact with automobile finish 34 and rotating the buffer element counterclockwise, as indicated by arrows 40 in FIG. 3, with respect to the automobile finish. The adjustable handle 20 can also be moved as indicated by arrows 42 in FIG. 1 as required by the technician.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. An automobile finish buffer comprising:
A) a housing;
B) a support handle mounted on the housing;
C) an adjustable handle movably mounted on the housing to move clockwise and counterclockwise with respect to the housing;
C) a pneumatic motor in the housing, the motor operating in a counterclockwise direction with respect to the housing and with respect to the support handle; and
D) a buffer element mounted on the motor for rotation, the buffer rotating counterclockwise with respect to a workpiece when the buffer is interposed between the workpiece and the support handle.

2. A method of buffing an automobile finish comprising:
A) placing a buffer element in contact with an automobile finish; and
B) rotating the buffer element counterclockwise with respect to the automobile finish.

3. The method defined in claim 2 further including a step of connecting the buffer element to a motor and operating the motor pneumatically.
